(19) United States
(12) Patent Application Publication
(10) Pub. No.: US 2016/0203564 A1
(43) Pub. Date: Jul. 14, 2016

(54) SYSTEM AND METHOD FOR CONSOLIDATING EXPENSE RECORDS

(71) Applicant: Vatbox, Ltd., Herzliya (IL)

(72) Inventors: Isaac Saft, Kfar Neter (IL); Noam Guzman, Ramat Hasharon (IL)

(73) Assignee: Vatbox, Ltd., Herzliya (IL)

(21) Appl. No.: 14/994,387

(22) Filed: Jan. 13, 2016

Related U.S. Application Data
(60) Provisional application No. 62/102,633, filed on Jan. 13, 2015.

(51) Int. Cl. G06Q 40/00; G06F 17/30

(52) U.S. Cl. CPC G06Q 40/12; G06F 17/30085

(57) ABSTRACT

A system and method for consolidating expense records. The method includes receiving, from a first source, a first file including at least one activity identifier; analyzing the first file to identify the at least one activity identifier; retrieving, based on the at least one activity identifier, at least one second file from a second source, wherein the at least one second file corresponds to the first file; comparing the first file to each of the at least one second file to identify a difference; and generating, based on at least one causation rule, at least a metadata respective of the identified difference.

### CROSS-REFERENCE TO RELATED APPLICATIONS

This application claims the benefit of U.S. Provisional Application No. 62/102,633 filed on Jan. 13, 2015, the contents of which are hereby incorporated by reference.

### TECHNICAL FIELD

The present disclosure relates generally to verifying files in data systems, and more specifically to verifying files in data systems based on file content.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information before authorizing the sale. The verification typically includes determining whether the credit card information is valid (i.e., that a credit card number, expiration date, PIN code, and/or customer name match known information).

Upon receiving such assurances, a purchase order may be generated for the customer. The purchase order provides evidence of the order such as, for example, a purchase price. Subsequently, an invoice may be generated. While the purchase order is usually used to indicate which products are requested, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases where the total price of the invoice is different from the total price of the purchase order are difficult to track, especially in large enterprises accepting many orders daily. The differences may cause errors in recordkeeping for enterprises.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for consolidating expense records. The method includes receiving, from a first source, a first file including at least one activity identifier; analyzing the first file to identify the at least one activity identifier; retrieving, based on the at least one activity identifier, at least one second file from a second source, wherein the at least one second file corresponds to the first file; comparing the first file to each of the at least one second file to identify a difference; and generating, based on at least one causation rule, at least a metadata respective of the identified difference.

The disclosed embodiments also include a system for consolidating expense records. The system includes a processing unit; and a memory, the memory containing instructions that, when executed by the processing unit, configure the system to: receive, from a first source, a first file including at least one activity identifier; analyze the first file to identify the at least one activity identifier; retrieve, based on the at least one activity identifier, at least one second file from a second source, wherein the at least one second file corresponds to the first file; compare the first file to each of the at least one second file to identify a difference; and generate, based on at least one causation rule, at least a metadata respective of the identified difference.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for identifier-based verification according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

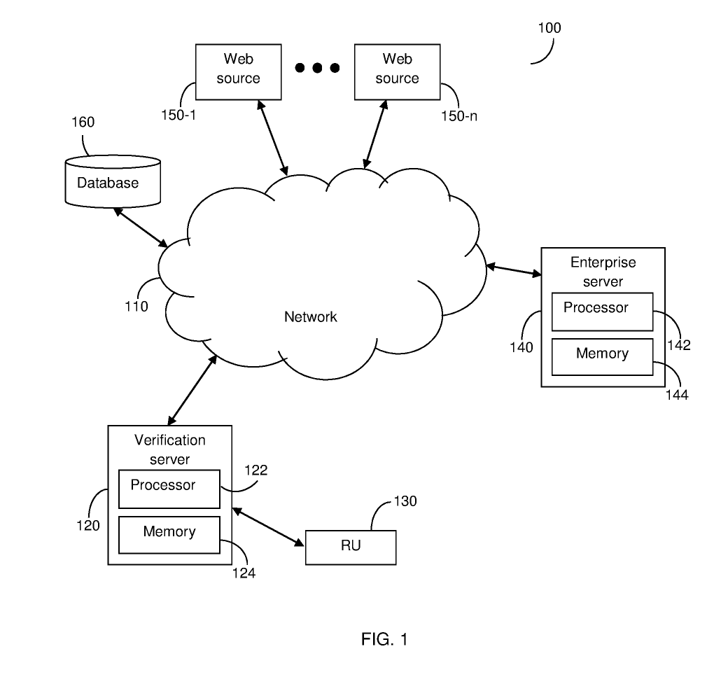

FIG. 1 shows an exemplary and non-limiting network diagram 100 utilized to describe the various disclosed embodiments. A network 110 is communicatively connected to a verification server 120, an enterprise server 140, a plurality of web sources 150 (hereinafter referred to individually as a web source 150 and collectively as web sources 150, merely for simplicity purposes), and a database 160. The network 110 may be, but is not limited to, a local area network (LAN), a wide area network (WAN), a metro area network (MAN), the worldwide web (WWW), the Internet, a wired network, a wireless network, similar networks and any combinations thereof.

The verification server 120 may be communicatively connected to a recognition unit (RU) 130. The recognition unit 130 is configured to execute machine imaging processes. The recognition unit 130 may include, but is not limited to, an optical character recognition unit, an image recognition unit, and a combination thereof.

The web sources 150 may include, but are not limited to, merchant devices, tax authority servers, accounting servers, a database associated with the entity, and so on. The web sources 150 may store and allow for retrieval of files including but not limited to, invoices. The database 160 may store financial data respective of the enterprise. Such financial data may include, but is not limited to, data related to expenses actually made by the enterprise (e.g., a final total price for each invoice).

The enterprise server 140 may be communicatively connected to the verification server 120 over the network 110. The enterprise server 140 may be controlled by an entity belonging to an enterprise. In an embodiment, the verification server 120 is configured to receive a request from the enterprise server 140 to verify one or more purchase orders over the network 110. Each purchase order may include or otherwise indicate a transaction number (i.e., an order number). The request may include the purchase orders. As a non-limiting example, each purchase order may relate to a travel product or service such as a flight ticket (also known as a purchase number record), a hotel reservation, a shuttle service, and so on.

The verification server 120 may be configured to analyze the purchase orders to identify activity identifiers of the purchase orders. The activity identifiers relate to activities conducted by the enterprise such as, but not limited to, orders (e.g., sales of products). The activity identifiers may include, but are not limited to, merchant information (e.g., name or address), purchase information (e.g., transaction number, product name, product description, quantity, expense, etc.), and so on. In an embodiment, the analysis may include machine imaging analysis of the purchase order via the recognition unit 130. As an example, optical character recognition may be utilized to identify a merchant name in an image of a purchase order.

Based on the activity identifiers, the verification server 120 is configured to identify one of the web sources 150 (e.g., the web source 150-1) from which an invoice corresponding to the purchase order can be extracted. The verification server 120 is configured to extract the corresponding invoice from the identified web source 150-1. The extraction may further include comparing activity identifiers of each corresponding invoice to the activity identifiers of the purchase order to determine a matching invoice. As an example, an invoice may be determined to match a purchase order if the invoice and the purchase order include the same order number.

In an embodiment, the verification server 120 is configured to analyze the retrieved invoice to determine an activity identifier included therein and to compare the determined invoice activity identifier to one of the purchase order activity identifiers. In an embodiment, the analysis may include retrieving an activity identifier from the database 160. As an example, the comparison may be based on expenses reflected in the purchase order and in the invoice, respectively, wherein the expense of the invoice is retrieved from a database.

In another embodiment, the verification server 120 may be configured to generate metadata respective of the difference. The notification may indicate the difference (or lack thereof), a potential cause of the difference, and so on. The difference may indicate a relationship between the expenses such as, but not limited to, a monetary value (e.g., $100.00, $1,000.00, $52.45, etc.), a proportion (e.g., 0.4, 0.57, 0.9, etc.), or any other function relating the expenses.

The potential causes of the difference may be, for example, circumstances and/or assumptions related to the basis of the difference. The potential causes may be based on one or more causation rules respective of the difference in price. The causation rules may associate potential causes of the difference with particular values of the difference or multiples thereof. The causation rules may further be based on whether the difference is positive (i.e., the invoice expense is higher) or negative (i.e., the purchase order expense is higher).

As an example of a causation rule, for a purchase of a hotel stay in a particular room, a difference of +$100.51 between the expense of the purchase order and the expense of the invoice may be associated with 1 additional night's stay in that room, while a difference of −$100.51 may be associated with a refund for 1 night's stay in that room. In such an example, multiples of $100.51 (e.g., $201.02, $301.53, and so on) may be associated with respective numbers of additional nights (e.g., 2 nights, 3 nights, and so on, respectively).

The causation rules may be further based on products that are related to the purchase.

As another example, for a purchase of 2 computers at a price of $1,000 apiece, it may be determined that purchases of computer monitors typically occur along with this type of purchase and that a particular computer monitor costs $125.00. Accordingly, a difference of +$250.00 may be associated with a potential cause of purchasing two computer monitors at $125.00 apiece.

Alternatively or collectively, the causation rules may be related to differences in currency exchange rates, taxes (e.g., VAT taxes) which were not charged at a time of the order, incidental charges, gratuity charges, and other potential reasons as to why the original expense reflected in the purchase order and the final expense reflected in the invoice ultimately differed.

It should be understood that the embodiments disclosed herein are not limited to the specific architecture illustrated in FIG. 1, and other architectures may be equally used without departing from the scope of the disclosed embodiments. Specifically, each of the servers 120 and 140 may reside in a cloud computing platform, a datacenter, and the like. Moreover, in an embodiment, there may be a plurality of servers operating as described hereinabove and configured to either have one as a standby, to share the load between them, or to split the functions between them. It should be further noted that the recognition unit 130 may be integrated in the verification server 120 without departing from the disclosed embodiments.

The verification server 120 typically includes a processing unit 122 coupled to a memory 124. The second server 140 typically includes a processing unit 142 coupled to a memory 144. Each of the processing units 122 and 142 may comprise or be a component of a processor (not shown) or an array of processors coupled to the memory 124 or 144, respectively. The memories 124 and 144 contain instructions that can be executed by the processing units 122 and 142, respectively. The instructions, when executed by the processing unit 122 or 142, cause the processing unit 122 or 142 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

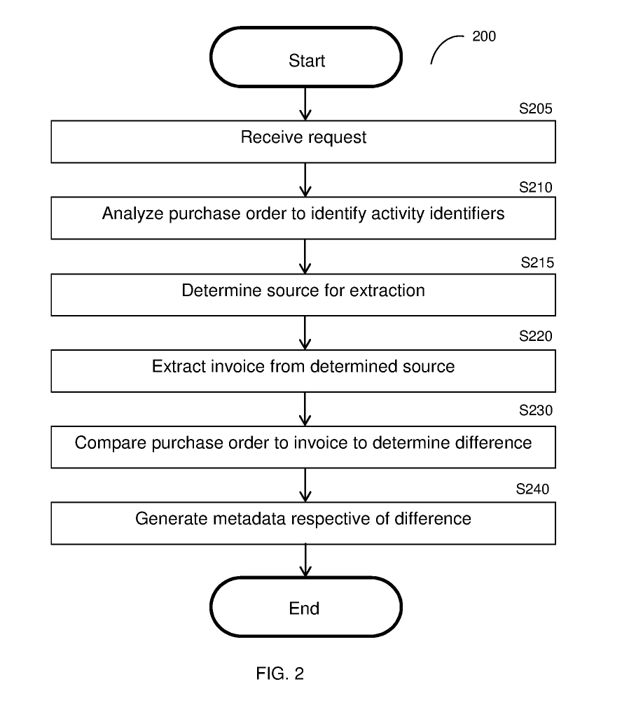

FIG. 2 is an exemplary and non-limiting flowchart 200 illustrating a method for identifier-based verification according to an embodiment. In an embodiment, the method may be performed by a server (e.g., the verification server 120).

In S205, a request to verify a purchase order respective of an invoice is received. The request may include the purchase order. The request may be received from a user node connected to the network and operated by a user (e.g., a bookkeeper). Alternatively, the request may be received from an accounting and/or bookkeeping software application executed on a user node.

In S210, the purchase order included in the request is analyzed to identify one or more activity identifiers respective of an invoice associated with the purchase order.

In S215, a source from which the associated invoice can be extracted is determined based on the activity identifiers. The source may be, but is not limited to, a web source such as, e.g., a merchant device, a tax authority server, an accounting server, a database associated with an enterprise, and so on. In an embodiment, the determination may further include extracting data related to the invoices in the web sources from a database. The data may include, but is not limited to, activity identifiers of the invoices. In particular, the activity identifiers may include order numbers of the invoices and expenses for the invoices.

In S220, the associated invoice is extracted from the determined source. The extraction may further include comparing an order number identified in one of the determined activity identifiers to the order numbers of the extracted invoice to determine a matching invoice respective of the order numbers. The matching invoice may be extracted from the source.

In S230, the purchase order and the associated invoice are compared to determine whether there is a difference. In an embodiment, S230 may further include analyzing the associated invoice to identify an invoice activity identifier and determining a difference between the invoice activity identifier and one of the purchase order activity identifiers. As an example, the expense in the purchase order and in the invoice may be compared to determine a monetary difference between the prices. As another example, the goods and/or services listed in the purchase order are matched against those mentioned in the invoice to determine any difference.

In S240, metadata is generated respective of the determined difference. The metadata may include the difference, if any. In an embodiment, the metadata may further include one or more potential causes of the difference such as, for example, circumstances or assumptions related to the difference. In a further embodiment, the potential causes of the difference may be based on one or more causation rules associating causes with particular relationships between the expenses.

In an embodiment, S240 may further include generating a notification including the metadata. The generated notification may be sent to the source of the request (e.g., a merchant or accountant seeking to consolidate expense records).

As a non-limiting example, a request including a purchase order related to a purchase of a $50.00 baseball card set is received from a server owned by a merchant. The purchase order is analyzed to identify activity identifiers including a merchant name “ABC Collectibles,” an order number of “123-456” and a purchase order expense of $50.00. Based on the merchant name, a merchant device associated with ABC Collectibles is determined for extracting an associated invoice. Data including the order numbers of the invoices is extracted. An invoice associated with the order number “123-456” is identified and extracted from the merchant device. The invoice is analyzed to identify an invoice expense of $100.00. The expenses are compared to determine a difference of +$50.00. Based on a causation rule, it is determined that the $50.00 increase is associated with purchasing a second $50.00 baseball card set after the initial order. Metadata indicating the $50.00 difference and the potential cause of the difference is generated. A notification including the metadata is generated and sent to the merchant (via, e.g., the merchant's server).

As another non-limiting example, a request including a purchase order related to a reservation of a 3-night hotel room is received. The purchase order is analyzed to identify activity identifiers including a hotel name, location, dates for the stay, and a purchase order expense of $750.00. Based on the information recognized in the purchase order, the hotel accounting server (e.g., a web server), is queried to retrieve a corresponding invoice.

The retrieved invoice is analyzed to identify an invoice expense of [symbol] 650.00. The expenses are compared to determine a difference in the currencies and in the total sum. Based on a causation rule, it is determined that the difference in the total amounts are due to differences in currencies (USD versus Euros) between the price listed in the purchase order and the actual charges listed in the invoice. The analysis of the purchase order and invoices shows that the total [symbol] 650.00 matches the $750.00 reservation when applying the exchange rate at the day of the stay. Thus, metadata indicating the difference and the potential cause of the difference is generated. A notification including the generated metadata is generated and sent to the device providing the initial request.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for electronically consolidating expense records, comprising:
receiving, from a first source, a first file including at least one activity identifier;
analyzing the first file to identify the at least one activity identifier;
retrieving, based on the at least one activity identifier, at least one second file from a second source, wherein the at least one second file corresponds to the first file;
comparing the first file to each of the at least one second file to identify a difference; and
generating, based on at least one causation rule, at least a metadata respective of the identified difference.

2. The method of claim 1, wherein the at least a metadata includes at least one of: the difference, and a potential cause of the difference.

3. The method of claim 1, wherein comparing the first file to each of the at least one second file to identify a difference further comprises:
analyzing the first file to identify a first expense;
analyzing the at least one second file to identify a second expense; and
comparing the first expense and the second expense.

4. The method of claim 3, wherein the difference is between the first expense and the second expense.

5. The method of claim 3, wherein the analysis of the first file and the analysis of the at least one second file includes executing at least one machine imaging process to identify the first expense and the second expense, respectively.

6. The method of claim 1, wherein retrieving the second file from the second source further comprises:
determining, based on the at least one activity identifier, the second source from which at least one associated file may be retrieved respective of the first file; and
extracting, from the second source, the at least one second file.

7. The method of claim 6, wherein extracting the at least one second file further comprises:
comparing the first file to each file of the second source to determine a match; and
upon determining a match, identifying at least one matching file from the second source as the at least one second file.

8. The method of claim 1, wherein the first file is a purchase order and each of the at least one second file is an invoice corresponding to the purchase order.

9. The method of claim 1, further comprising:
generating a notification including at least the metadata.

10. A non-transitory computer readable medium having stored thereon instructions for causing one or more processing units to execute the method according to claim 1.

11. A system for identifier-based verification in data systems, comprising:
a processing unit; and
a memory, the memory containing instructions that, when executed by the processing unit, configure the system to:
receive, from a first source, a first file including at least one activity identifier;
analyze the first file to identify the at least one activity identifier;
retrieve, based on the at least one activity identifier, at least one second file from a second source, wherein the at least one second file corresponds to the first file;
compare the first file to each of the at least one second file to identify a difference; and
generate, based on at least one causation rule, at least a metadata respective of the identified difference.

12. The system of claim 11, wherein the at least a metadata includes at least one of:
the difference, and a potential cause of the difference.

13. The system of claim 11, wherein the system is further configured to:
analyze the first file to identify a first expense;
analyze the at least one second file to identify a second expense; and
compare the first expense and the second expense.

14. The system of claim 13, wherein the difference is between the first expense and the second expense.

15. The system of claim 13, wherein the analysis of the first file and the analysis of the at least one second file includes executing at least one machine imaging process to identify the first expense and the second expense, respectively.

16. The system of claim 11, wherein the system is further configured to:
determine, based on the at least one activity identifier, the second source from which at least one associated file may be retrieved respective of the first file; and
extract, from the second source, the at least one second file.

17. The system of claim 16, wherein the system is further configured to:
compare the first file to each file of the second source to determine a match; and
upon determining a match, identify at least one matching file from the second source as the at least one second file.

18. The system of claim 11, wherein the first file is a purchase order and each of the at least one second file is an invoice corresponding to the purchase order.

19. The system of claim 11, wherein the system is further configured to:
generate a notification including at least the metadata.
